(19) United States
(12) Patent Application Publication
(10) Pub. No.: US 2026/0288490 A1
(43) Pub. Date: Sep. 24, 2026

(54) INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Yasunari KISHIMOTO, Kanagawa (JP)

(73) Assignee: FUJIFILM Business Innovation Corp., Tokyo (JP)

(21) Appl. No.: 19/311,790

(22) Filed: Aug. 27, 2025

(30) Foreign Application Priority Data
Mar. 19, 2025 (JP) 2025-046028

(51) Int. Cl. G06F 9/451; G06F 3/0483; G06F 3/04845

(52) U.S. Cl. CPC G06F 9/451; G06F 3/0483; G06F 3/04845

(57) ABSTRACT

An information processing system includes a processor configured to: acquire first data, which is document data segmented per page in which a layout of objects included in a page is fixed; and generate, from the first data, second data for displaying the page in a display region, and the generating the second data includes configuring the second data so that when the page is displayed in the display region, an aspect ratio of each of one or more first objects representing one or more characters among the objects is restricted within a predetermined range and an aspect ratio of the whole page including a second object different from the one or more first objects among the objects is adjusted to an aspect ratio of the display region.

### CROSS-REFERENCE TO RELATED APPLICATIONS

This application is based on and claims priority under 35 USC 119 from Japanese Patent Application No. 2025-046028 filed March 19, 2025.

### BACKGROUND

### i. Technical Field

The present disclosure relates to an information processing system, a non-transitory computer readable medium, and an information processing method.

### ii. Related Art

Japanese Unexamined Patent Application Publication No. 2001-243151 discloses a browser system for viewing a web page on the Internet. The browser system includes display size changing means for changing a screen size of a web page to a screen size designated by a user.

Japanese Unexamined Patent Application Publication No. 2004-062465 discloses a method for displaying plural web pages on a display screen of an information processing apparatus. According to the method, allowable ranges of display sizes of pieces of content used in the plural web pages on the display screen are determined in advance, and the information processing apparatus determines, based on tag commands described in the plural web pages to be displayed, whether or not the display sizes of the pieces of content used in the web pages to be displayed are within the allowable ranges, and as for a web page determined as being out of the allowable range, changes the tag command described in the web page so that the display size falls within the allowable range, and changes content used in the web page so that the display size falls within the allowable range.

Japanese Unexamined Patent Application Publication No. 2009-163326 discloses a markup language document conversion device that includes means for acquiring a first markup language document written in a first markup language and at least one of accompanying data and program, means for rendering the acquired first markup language document and the at least one of the data and program and checking coordinates of display elements to be drawn on a display screen having a specified size, means for converting the first markup language document into a second markup language document written in a second markup language by rearranging the display elements on the basis of the display elements and the coordinates thus checked, and means for storing the second markup language document.

### SUMMARY

Using data configured so that a layout of objects is automatically adjusted to match an aspect ratio of a display region allows a document indicated by identical data to be displayed in display regions of various aspect ratios. On the other hand, in a case where document data segmented per page in which a layout of objects included in a page is fixed is used as it is and a document indicated by the document data is displayed in display regions of various aspect ratios, visibility may undesirably decrease. For example, a blank space is created in a display region or a part of a page is cut off from a display region. Conventionally, in a case where a document of such document data is displayed so as to match an aspect ratio of a display region, an aspect ratio of a whole page including objects is simply adjusted to the aspect ratio of the display region, for example, by converting the document data into an image. However, in this case, an aspect ratio of characters also changes without any restriction so as to match the aspect ratio of the display region. This may undesirably lower readability of the characters.

Aspects of non-limiting embodiments of the present disclosure relate to a technique of generating data that allows characters to be displayed with good visibility as compared with a case where a document of document data segmented per page in which a layout of objects included in a page is fixed is displayed as data that is displayed so as to match an aspect ratio of a display region by simply adjusting an aspect ratio of a whole page including objects to the aspect ratio of the display region.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to: acquire first data, which is document data segmented per page in which a layout of objects included in a page is fixed; and generate, from the first data, second data for displaying the page in a display region, in which the generating the second data includes configuring the second data so that when the page is displayed in the display region, an aspect ratio of each of one or more first objects representing one or more characters among the objects is restricted within a predetermined range and an aspect ratio of the whole page including a second object different from the one or more first objects among the objects is adjusted to an aspect ratio of the display region.

### BRIEF DESCRIPTION OF THE DRAWINGS

An exemplary embodiment of the present disclosure will be described in detail based on the following figures, wherein:

FIG. 1 is a diagram for explaining an example of a scene where an information processing system according to an exemplary embodiment of the present disclosure is used;

FIG. 2 is a diagram illustrating an example of a hardware configuration of the information processing system according to the exemplary embodiment of the present disclosure;

FIG. 3 is diagram illustrating an example of a functional configuration of the information processing system according to the exemplary embodiment of the present disclosure;

FIG. 4 illustrates an example of flow of information processing executed by the information processing system according to the exemplary embodiment of the present disclosure;

FIG. 5 illustrates an example of a page displayed on the basis of first data;

FIG. 6 illustrates, as a comparative example, an example of a page displayed in a case where an aspect ratio of the whole page including objects is merely adjusted to an aspect ratio of a display region; and

FIG. 7 illustrates an example of a page displayed on the basis of second data.

### DETAILED DESCRIPTION

An exemplary embodiment of the present disclosure is described below with reference to the drawings. Note that identical or equivalent constituent elements and parts in the drawings are given identical reference signs. Dimensional ratios in the drawings may be exaggerated for convenience of description and may be different from actual ratios.

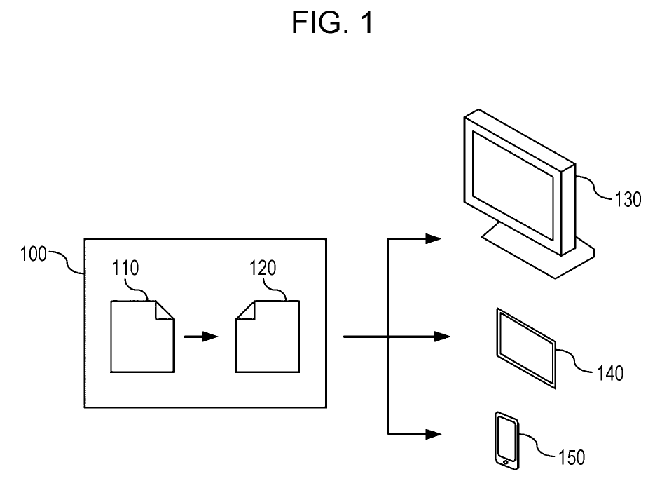

FIG. 1 is a diagram for explaining an example of a scene where an information processing system 100 according to the exemplary embodiment of the present disclosure is used.

FIG. 1 illustrates a scene where second data 120 is generated from first data 110 and the second data 120 is used to display display content of the first data 110 in display regions of various devices in the information processing system 100. In FIG. 1, a desktop personal computer 130, a tablet terminal 140, and a smartphone 150 are illustrated as the various devices.

The information processing system 100 may be, for example, a computer.

The first data 110 is document data segmented per page in which a layout of objects included in a page is fixed. The first data 110 may be data written in a page description language such as PostScript. For example, the first data 110 may be PDF format data. The first data 110 may be page-independent data. The first data 110 may be non-responsive web design data. The first data 110 may be data that incorporates a concept of pages. For example, the first data 110 may be Microsoft PowerPoint (PowerPoint (Registered Trademark)) format data or may be Microsoft Word (MS Word) format data. In a case where the concept of pages is not clearly defined (e.g., Microsoft Excel format), the first data 110 may be document data with a layout designed to fit in a single page.

The second data 120 may be data for displaying, in a display region, information indicated by a page of the first data 110. The second data 120 may be data written in a markup language such as HTML format data. The second data 120 may be non-page-independent data. The second data 120 may be responsive web design data. That is, the second data 120 may be data having a mechanism that automatically changes a layout in accordance with a size of a display region such as a screen of a device on which a website is used. The second data 120 may be HTML format data having a program function that makes it possible to responsively display the data in a display region. Note that in a case where the present specification contains a mention about configuring the second data 120 to have a predetermined function, this may mean that a program function that makes it possible to realize the function is incorporated into the second data 120.

In a case where information indicated by data is displayed in full-screen on a device, a size of the display region on the device may be a size of a display screen. In a case where information indicated by data is displayed in a display region of an application or a web browser, a size of the display region may be a size of the display region of the application or the web browser. The second data 120 may be data having a mechanism that changes a layout following change in size of the display region that occurs during display of the data. Note that in a case where the present specification contains a mention about "maintaining" a certain state, this may mean that the state is maintained irrespective of the size of the display region in a case where data is displayed in the display region and/or that the state is maintained even in a case where the size of the display region changes during display of data.

As described above, the information processing system 100 is used to generate the second data 120 from the first data 110. The generated second data 120 may be used to display information indicated by the data on various devices. For example, in a case where PDF format data created in a headquarter of an organization is to be displayed on various devices placed in branch offices, the data may be converted into a single piece of HTML format data and the HTML format data may be distributed to the branch offices instead of preparing pieces of image data having sizes corresponding to the devices and distributing the pieces of image data to the branch offices.

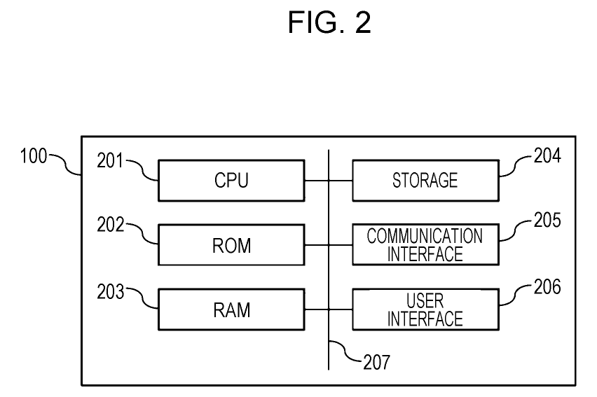

FIG. 2 is a diagram illustrating an example of a hardware configuration of the information processing system 100 according to the exemplary embodiment of the present disclosure.

The information processing system 100 includes a CPU 201, a read only memory (ROM) 202, a random access memory (RAM) 203, a storage 204, a communication interface 205, and a user interface 206. These constituent elements are communicably connected to one another by a bus 207.

The CPU 201 executes various programs and controls the constituent elements. The ROM 202 stores therein various programs and various data. The RAM 203 serves as a working area and temporarily stores therein a program or data. The storage 204 is a hard disk drive (HDD) or a solid state drive (SSD) and stores therein various programs including an operating system and various data. The ROM 202 or the storage 204 may store therein a trained model that outputs a degree of association between characters upon input of the characters. The trained model may be artificial intelligence such as a large language model.

In the information processing system 100 according to the present exemplary embodiment, an information processing program is stored in the ROM 202 or the storage 204. The CPU 201 controls the constituent elements and executes various kinds of arithmetic processing in accordance with the information processing program by reading out the information processing program from the ROM 202 or the storage 204 and executing the information processing program while using the RAM 203 as a working area.

The communication interface 205 is an interface for communication of the information processing system 100 with another apparatus. The user interface 206 is an input output interface used for exchange of information between the information processing system 100 and a user, that is, a player. The user interface 206 may include, as input devices, a game controller having an operation button, a directional pad, and the like, a touch panel, a keyboard, a microphone, and the like and include, as output devices, a monitor, a speaker, and the like.

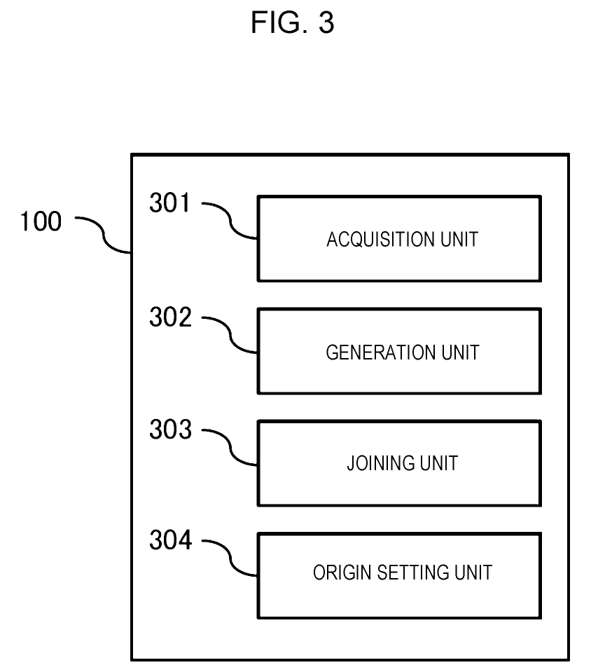

FIG. 3 is a diagram illustrating an example of a functional configuration of the information processing system 100 according to the exemplary embodiment of the present disclosure.

The information processing system 100 includes, as functional elements, an acquisition unit 301, a generation unit 302, a joining unit 303, and an origin setting unit 304. The functional elements are realized by the CPU 201 reading out the information processing program stored in the ROM 202 or the storage 204, loading the information processing program into the RAM 203, and executing the information processing program.

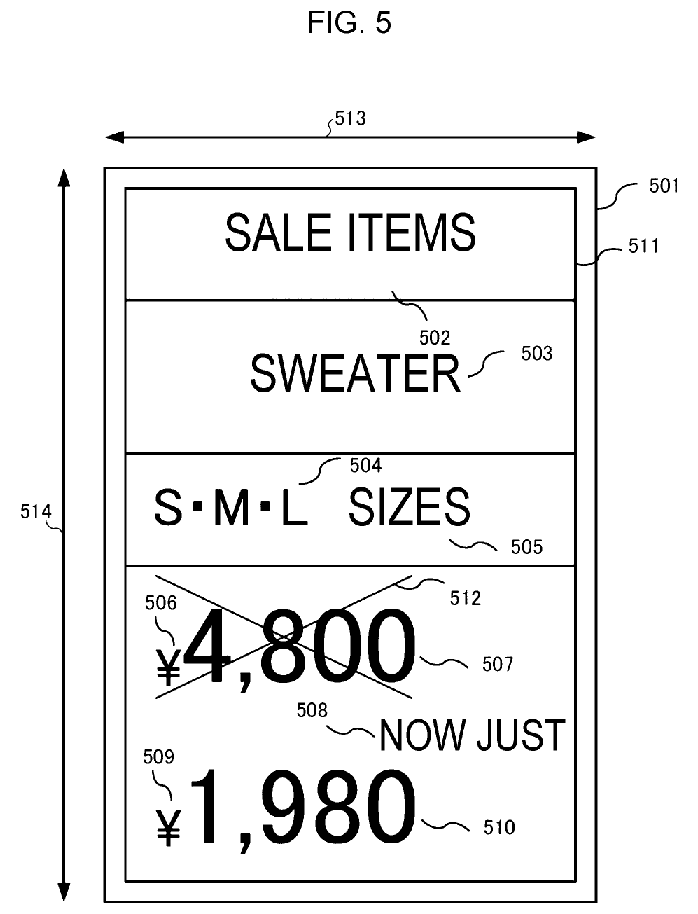

The acquisition unit 301 acquires first data, which is document data segmented per page in which a layout of objects included in a page is fixed. For example, the acquisition unit 301 acquires first data for displaying a page such as the one illustrated in FIG. 5, which will be described later.

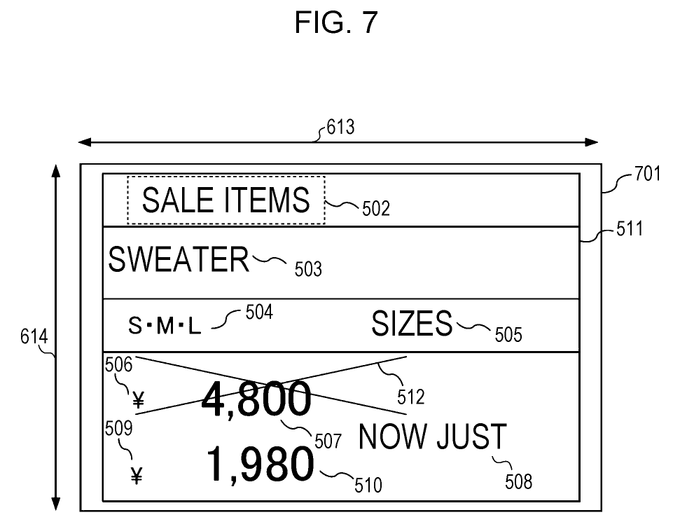

The generation unit 302 generates, from the first data, second data for displaying the page in a display region. For example, the generation unit 302 generates second data for displaying, in a display region, a page such as the one illustrated in FIG. 7, which will be described later.

The generation unit 302 may configure the second data so that when the page is displayed in the display region, an aspect ratio of each of one or more first objects representing one or more characters among the objects is restricted within a predetermined range and an aspect ratio of the whole page including a second object different from the one or more first objects among the objects is adjusted to an aspect ratio of the display region.

The generation unit 302 may configure the second data so that when the page is displayed in the display region, the one or more first objects are placed in the display region on the basis of an origin serving as a basis used to place the one or more first objects in the display region.

The generation unit 302 may configure the second data so that when the one or more first objects are placed in the display region, a relative positional relationship of the origin relative to the display region is maintained and the origin and the one or more first objects maintain a predetermined positional relationship.

The joining unit 303 may join plural characters represented by the one or more first objects as a character string in a case where the characters satisfy a predetermined criterion.

The origin setting unit 304 may set an origin for each character or each character string represented by the one or more first objects. The predetermined criterion is that a spacing between the plural characters satisfies a predetermined criterion, that the plural characters match a character string registered in advance, and/or that a degree of association between the plural characters that is output by inputting the characters to a trained model that outputs a degree of association between characters upon input of the characters satisfies a predetermined criterion. In a case where the degree of association between the characters output from the trained model is used as a criterion for joining of characters, the trained model stored in the ROM 202 or the storage 204 may be used.

The one or more first objects displayed in the display region may be vectorized objects. In this case, the generation unit 302 may configure the second data so that when the vectorized objects are displayed in the display region, an invisible character having information on the character represented by the one or more first objects is placed in the display region on the basis of the origin.

The generation unit 302 may configure the second data so that when the page is displayed in the display region, a ratio of a size of the one or more first objects in the display region to a size of the one or more first objects in the page is maintained at a smaller one of a ratio of a height of the display region to a height of the page and a ratio of a width of the display region to a width of the page.

The generation unit 302 may configure the second data so that when the page is displayed in the display region, an aspect ratio of a third object that exhibits a function by being read among the objects is restricted within a predetermined range.

The generation unit 302 may configure the second data so that when the page is displayed in the display region, auxiliary information added to the objects is displayed by using a hover effect.

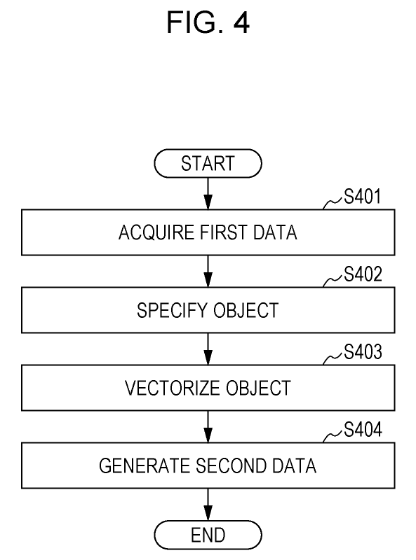

FIG. 4 illustrates an example of flow of information processing executed by the information processing system 100 according to the exemplary embodiment of the present disclosure.

In step S401, the CPU 201 as the acquisition unit 301 acquires the first data. The first data is document data segmented per page in which a layout of objects in a page is fixed.

In step S402, the CPU 201 as the generation unit 302 specifies objects included in a page. The CPU 201 as the generation unit 302 may specify one or more first objects representing one or more characters among the objects. Objects 502 to 510 included in a page 501 illustrated in FIG. 5, which will be described later, are an example of the first objects included in the page. Furthermore, the CPU 201 as the generation unit 302 may specify the second object different from the first objects among the objects. The second object is an object whose aspect ratio is to be changed in coordination with the whole page. Objects 511 and 512 included in the page 501 illustrated in FIG. 5, which will be described later, are an example of the second object.

The page may include various kinds of objects such as a character, an image, an illustration, a table, a barcode, and a link. Note that the objects may be visual document elements. Among the objects, the CPU 201 may specify an object whose aspect ratio is to be restricted within a predetermined range and an object whose aspect ratio is to be changed in coordination with the whole page. An object that does not degrade visibility much when scaled up or down, such as a line of a table, an image, or an illustration, may be handled as a part of background of the page. These objects may be specified on the basis of a data structure of the first data. However, it is assumed that the first data is held in various formats. Therefore, the acquired first data may be converted into intermediate data to handle the first data as data having a data structure having a uniform format. In the intermediate data, data of the objects may be independently held.

In this stage, the CPU 201 as the joining unit 303 may join plural characters represented by the one or more first objects as a character string in a case where the characters satisfy a predetermined criterion. In PDF format data, information is sometimes held per character. In data that does not hold edit information, a character string is sometimes segmented. By performing processing for joining characters as a unit to be handled as a character string, a character string may be used as a unit collectively handled when characters are placed in the display region. The joining processing may be executed on the intermediate data.

The predetermined criterion may be that a spacing between the characters satisfies a predetermined criterion, for example, that a half-width space included in characters in one row is equal to or less than a width corresponding to one character. The predetermined criterion may be that the characters match a character string registered in advance. For example, a term may be searched for by referring to data of a term dictionary to determine whether or not to join segmented characters on the basis of the criterion. The predetermined criterion may be that a degree of association between characters that is output by inputting the characters to a trained model that outputs a degree of association between characters upon input of the characters satisfies a predetermined criterion. Specifically, it may be determined whether characters are a character string on the basis of a phrase and character position coordinates that are output by inputting characters located at close positional coordinates to a generative artificial intelligence.

The criterion used to determine whether or not to join segmented characters is not limited to these. The character string need not necessarily be a term. Joining characters located at close positional coordinates does not create an unnecessary space and therefore makes the character easily readable in a case where the characters have the same font type or size. Therefore, the predetermined criterion may be that the characters have the same font type or the same character size. A font type or a character size may be recognized by vectorizing a character object based on a display size or may be recognized by using a temporary standard font. Furthermore, it may be determined whether the characters are written vertically or horizontally. A layout dictionary may be registered for a layout pattern, and it may be determined whether or not to join characters on the basis of the layout dictionary as for the first data having a layout similar to the layout pattern. In this case, an error may be corrected by using an algorithm.

In the stage of specifying the objects, the CPU 201 as the origin setting unit 304 may set an origin for each character or each character string represented by the one or more first objects. A position of a point corresponding to an object may be specified on the basis of coordinate information held in the first data. The origin is a point serving as a basis used to place an object. Details of the origin will be described later with reference to FIG. 7. By setting a basis used to place an object, objects representing a character may be regularly placed within the display region. The origin may be set for each character or may be set for each character string. By setting a basis used to place an object representing a character string, the objects representing characters may be placed within the display region in units of character strings. The origin may be a representative point representing a position of a character or a character string in a page and allocated to the character or the character string. A position of the representative point relative to the whole page may be used to place the character or the character string in the display region in accordance with a change in aspect ratio of the display region. In a case where the origin is set for the whole page and a relative position thereof is maintained in the display region, the objects representing a character may be placed in the whole display region.

In this stage, the CPU 201 as the generation unit 302 may determine the third object that exhibits a function by being read among the objects. The third object is, for example, an object representing a barcode or a QR code (Registered Trademark). Furthermore, in this stage, the CPU 201 as the generation unit 302 may add, to the object, auxiliary information to be displayed by using a hover effect. Examples of the auxiliary information include a linked screen added to a link and translation information added to characters written in a certain language. Another example of the auxiliary information is an animation added to an illustration.

In step S403, the CPU 201 as the generation unit 302 vectorizes the specified objects. Not all of the objects need to be vectorized by the CPU 201. For example, the CPU 201 vectorizes the one or more first objects representing one or more characters among the objects. The vectorization may be specifically a process of generating an outline and outputting the outline as vector data in SVG format. That is, an object compatible with SVG format such as a drawing path or an image need not be vectorized. In general, raster format data such as JPEG and PNG are made up of pixels, whereas vector format data such as SVG are made up of mathematical curves and lines. The vectorized object does not depend on resolution, and therefore scaling up or down does not degrade visibility much. The object to be vectorized is not limited to the first object, and an object for which reducing influence of scaling on visibility is desired may be vectorized.

Note that the vectorized object itself does not hold information on a character. Therefore, in a case where the one or more first objects are vectorized, the CPU 201 as the generation unit 302 may generate an invisible character holding information on the character represented by the one or more first objects. This allows character information used for search or copy to be placed within the display region together with the vectorized object that cannot be used for search or copy.

In step S404, the CPU 201 as the generation unit 302 generates the second data for displaying the page in the display region. In this case, the CPU 201 as the generation unit 302 may configure the second data so that when the page is displayed in the display region, an aspect ratio of each of the one or more first objects representing one or more characters among the objects is restricted within a predetermined range and an aspect ratio of the whole page including a second object different from the one or more first objects among the objects is adjusted to an aspect ratio of the display region.

By restricting the aspect ratio of each of the one or more first objects representing one or more characters among the objects within the predetermined range, the characters may be displayed with good visibility. Furthermore, by adjusting the aspect ratio of the whole page including the second object different from the one or more first objects to the aspect ratio of the display region, content of the whole page fits within the display region. This allows a user to view the content of the whole page without scrolling. Furthermore, this allows the user to view the content of the whole page with no margin left in the display region.

Specifically, the second data may be structured data that includes a program function that scales a screen displayed on the display region upon input of a size of the display region. For example, the second data may be SVG or HTML that may include reference CSS, a program (e.g., JavaScript (Registered Trademark), WebAssembly, or a binary format), or the like. The second data may be output as display data for displaying display data by a web application. Such display data may be generated by a build generation technique. Specifically, a framework such as virtual DOM of React (Registered Trademark), Svelte, or Solid may be used for build of HTML. This is because in a case where a document object model (DOM) is used, delay may occur in display speed of initial display or a next page.

Regarding the predetermined range within which the aspect ratio of each of the one or more first objects representing one or more characters among the objects is restricted, for example, a rate of change of one of a height and a width of an object relative to the other may be 1, may be equal to or greater than 0.5 and equal to or less than 1.5, or may be equal to or greater than 1 and equal to or less than 2. For example, in a case where an aspect ratio of an object changes from 1 : 1 to 2 : 3, a ratio of the width to the height 1 changes from 1 to 1.5. In this case, the rate of change of the width is 1.5. In a case where it is determined in advance that the rate of change of the width is restricted within a range equal to or greater than 1 and equal to or less than 1.5, the aspect ratio of the object may be restricted so that the rate of change of the width relative to the height of the object falls within this range. The predetermined range may be set freely in consideration of readability of characters. The predetermined range may be controlled in accordance with a manner in which characters are displayed, such as a font type, a type design, a half-width, a full-width, kanji, hiragana, or an alphabetical letter. By keeping the aspect ratio of the first object within the predetermined range, character readability may be maintained.

The CPU 201 as the generation unit 302 may configure the second data so that when the page is displayed in the display region, the one or more first objects are placed in the display region on the basis of an origin serving as a basis used to place the one or more first objects in the display region. Furthermore, in this case, the CPU 201 as the generation unit 302 may configure the second data so that when the one or more first objects are placed in the display region, a positional relationship of the origin relative to the display region is maintained and the origin and the one or more first objects maintain a predetermined positional relationship.

For example, a central point of a text frame of an object to be placed is set as the origin, and the object may be placed so as to follow the position of the origin relative to the display region. The dotted line surrounding the object 502 in FIG. 7, which will be described later, is an example of the text frame. A positional relationship of the origin relative to the whole display region indicated by the second data may maintain the position of the origin relative to the whole page indicated by the first data.

A positional relationship between an origin and an object may be, for example, a positional relationship such that the origin coincides with an upper left corner of a text frame of the object or may be a positional relationship such that the upper left corner of the text frame of the object is deviated rightward from the origin by several centimeters. A common positional relationship may be applied to all objects or different positional relationships may be applied to respective pairs of an origin and an object. It may be decided from a positional relationship between the origins that objects are aligned on the basis of the origins, and thus relationships between the origins and the objects may be maintained. For example, in a case where plural origins are present on a straight line, left alignment of the objects may be maintained on the basis of the origins. In either case, objects representing characters may be placed while maintaining a regular relationship in the display region irrespective of a size of the display region. Note that a relationship between an origin and an object may be decided on the basis of a predetermined criterion or may be decided to achieve good visibility, for example, by using artificial intelligence.

Note that the one or more first objects displayed in the display region may be vectorized objects. The CPU 201 as the generation unit 302 may configure the second data so that when the vectorized objects are displayed in the display region, an invisible character holding information on the character represented by the one or more first objects is placed in the display region on the basis of the origin. This is because each of the vectorized objects visually represents the character but does not hold information on the character that enables search or copy. The invisible character may be placed at a position overlapping a corresponding one of the vectorized objects or may be placed close to a corresponding one of the vectorized objects. The invisible character may be placed on the basis of the origin, as with the vectorized objects. As described above, the invisible character may hold information on a character identical to the character represented by the vectorized objects. Therefore, character information used for search or copy may be placed within the display region together with the vectorized objects that cannot be used for search or copy.

The CPU 201 as the generation unit 302 may configure the second data so that when the page is displayed in the display region, a ratio of a size of the one or more first objects in the display region to the size of the one or more first objects in the page is maintained at a smaller one of a ratio of a height of the display region to a height of the page and a ratio of a width of the display region to a width of the page. This may suppress occurrence of a situation where the objects representing one or more characters do not fit in the display region.

The CPU 201 as the generation unit 302 may configure the second data so that when the page is displayed in the display region, an aspect ratio of a third object that exhibits a function by being read among the objects is restricted within a predetermined range. The third object is, for example, an object representing a two-dimensional code. Specific examples of the two-dimensional code are a barcode and a QR code (Registered Trademark). For example, in a case where a line of a barcode font is distorted, skewed, blurred, or too small, the barcode cannot be read by a reader. Therefore, by restricting change of the aspect ratio of the third object when converting the format of the first data including the third object, occurrence of a situation where the third object fails to function due to change of the aspect ratio of the third object may be suppressed.

The CPU 201 as the generation unit 302 may configure the second data so that when the page is displayed in the display region, auxiliary information added to the objects is displayed by using a hover effect. Note that the auxiliary information may be held in the form of embedded characters as an inline frame element. In either case, by displaying the auxiliary information in such a manner, the auxiliary information may be displayed without degrading visibility of the whole page.

In a case where the first data is data corresponding to plural pages, the CPU 201 as the generation unit 302 may configure the second data so that a whole one page among the plural pages is displayed in the display region and a page turning operation for displaying remaining pages that are not being displayed in the display region may be received.

FIG. 5 illustrates an example of a page displayed on the basis of the first data. FIG. 5 illustrates data showing commodity prices that is segmented per page (a page 501 is illustrated) and in which a layout of objects included in the page 501 is fixed. Although only the page 501 is displayed on the basis of the first data in this example, the first data may be data including plural pages. The objects 502 to 510 among the objects included in the page 501 are an example of the first objects representing one or more characters. The objects 511 and 512 among the objects included in the page 501 are an example of the second object whose aspect ratio is to be changed in coordination with the page 501.

The object 502 represents characters "SALE ITEMS", the object 503 represents characters "SWEATER", the object 504 represents characters "S·M·L", the objects 505 represents characters "SIZES", the object 506 represents a character "¥", the object 507 represents characters "4,800", the object 508 represents characters "NOW JUST", the object 509 represents a character "¥", and the object 510 represents characters "1,980".

Plural characters represented by an object are an example of plural characters joined as a character string by the joining unit 303. For example, the characters "S·M·L" represented by the object 504 are spaced apart from "SIZES" represented by the object 505 and are therefore characters joined as a character string separate from "SIZES". Furthermore, the character "¥" represented by the object 506 has a font size different from "4,800" represented by the object 507 and is therefore a character joined as a character string separate from "4,800".

The object 511 represents an illustration of a table, and the object 512 represents an illustration of a cross mark.

It is assumed that a height 514 of the page 501 is 30 cm and a width 513 of the page 501 is 20 cm. In this case, an aspect ratio of the page 501 is 3 : 2.

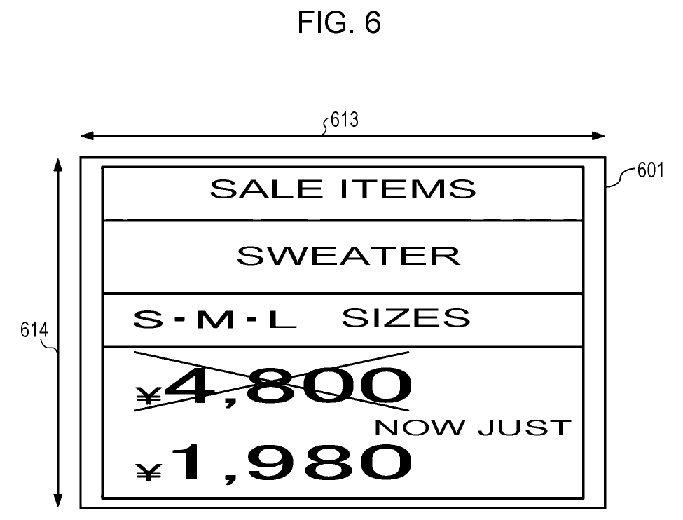

FIG. 6 illustrates, as a comparative example of the present disclosure, an example of a page displayed in a case where an aspect ratio of the whole page including all of the objects is merely adjusted in coordination with an aspect ratio of a display region.

FIG. 6 illustrates how the page appears in a case where the aspect ratio of the page 501 illustrated in FIG. 5 is merely adjusted to an aspect ratio of a display region 601. It may be understood that FIG. 6 illustrates, for example, a case where the page 501 is converted into an image and an aspect ratio of the image is adjusted.

It is assumed that a height 614 of the display region 601 is 6 cm and a width 613 of the display region 601 is 9 cm. In this case, the aspect ratio of the display region 601 is 2 : 3. The page 501 having an aspect ratio of 3 : 2 is adjusted to the aspect ratio 2 : 3 of the display region 601, and as a result an aspect ratio of each of the objects representing one or more characters also changes, and each of the objects is elongated in the direction of the width 613.

On the other hand, FIG. 7 illustrates an example of a page displayed on the basis of the second data. FIG. 7 illustrates how the page appears in a case where the whole page 501 including the object 502 to 511 illustrated in FIG. 5 is displayed in a display region 701 while using the second data as display data. It is assumed that the display region 701 has a height 614 of 6 cm and a width 613 of 9 cm, as with the display region 601 illustrated in FIG. 6. Among the objects 502 to 511, the aspect ratios of the objects 502 to 510, which are an example of the first objects representing one or more characters, have not been changed, and the aspect ratios of the objects 511 and 512, which are an example of the second object, have been adjusted to the aspect ratio of the display region 701. As illustrated in FIG. 7, change of the aspect ratios of the objects representing one or more characters is restricted, and therefore visibility of the displayed characters is better than that in the example of FIG. 6.

FIG. 7 illustrates how the page appears in a case where the objects 502 to 511 are placed in the display region 701 on the basis of origins. It is assumed that each of the origins is set at an upper left corner of a rectangular text frame surrounding a corresponding one of the objects 502 to 511 although the origins are not illustrated. The dotted line surrounding the object 502 in FIG. 7 is an example of the text frame. In the example of FIG. 7, a positional relationship of each of the origin positions relative to the dimensions of the page 501 managed by the first data is maintained as an origin position relative to the display region 701. This positional relationship of each of the origins relative to the display region 701 is an example of a positional relationship of an origin maintained relative to a display region. In the example of FIG. 7, each of the objects 502 to 511 is placed so that an upper left corner of the text frame thereof is located at a corresponding origin. This positional relationship between each of the objects 502 to 511 and a corresponding origin is an example of a predetermined positional relationship maintained by an origin and one or more first objects. Even in a case where the display region 701 is deformed while these objects are being displayed, a position of each origin relative to these display regions may be maintained and a positional relationship between each origin and a corresponding object may be maintained.

As for sizes of the objects 502 to 511, it may be understood that the sizes of the objects 502 to 511 displayed in the display region 701 are 0.2 times as large as the sizes of the objects 502 to 511 displayed in the page 501. A ratio of the height 614 (6 cm) of the display region 701 to the height 514 (30 cm) of the page 501 is 0.2 when expressed as a decimal. A ratio of the width 613 (9 cm) of the display region 701 to the width 513 (20 cm) of the page 501 is 0.45 when expressed as a decimal. Since the scaling ratio 0.2 of the height is smaller than the scaling ratio 0.45 of the width, the ratio of the sizes of the objects is controlled to maintain 0.2. For example, it is assumed that the rectangular text frame surrounding the characters "SALE ITEMS" represented by the object 502 in the page 501 represented by the first data has a height of 5 cm and a width of 18 cm. The object 502 has a height of 1 cm and a width of 3.6 cm when the size of the object 502 is reduced to 0.2 times. In this case, the object 502 representing the characters "SALE ITEMS" having a height of 1 cm and a width of 3.6 cm is displayed in the display region 701 having a height of 6 cm and a width of 9 cm.

By thus controlling the sizes of the objects in accordance with change of a dimension (a height or a width) exhibiting a greater reduction, occurrence of a situation where the objects representing one or more characters do not fit in the display region may be suppressed. On the other hand, for example, in a case where the size of the characters represented by the object 502 is adjusted in accordance with the width that has narrowed less, a proportion of the height of the object 502 to the height of the display region 701 increases. This may result in overlapping with another object or failure to contain the objects within the page. Note that although a case where the aspect ratios of the objects representing one or more characters does not change has been described in this example, the aspect ratio of each of the objects representing one or more characters may change, and in this case, the size of the characters may be changed on the basis of a dimension (a height or a width) of the object that narrows less. This may suppress occurrence of a situation where the objects representing one or more characters do not fit in the display region.

Although the exemplary embodiment has been illustrated as an example, the above exemplary embodiment may be modified in various ways or may be applied to various uses.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content. The program according to the present application may be provided as a program product.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing system including:

a processor configured to:

acquire first data, which is document data segmented per page in which a layout of objects included in a page is fixed; and

generate, from the first data, second data for displaying the page in a display region,

wherein the generating the second data includes configuring the second data so that when the page is displayed in the display region, an aspect ratio of each of one or more first objects representing one or more characters among the objects is restricted within a predetermined range and an aspect ratio of the whole page including a second object different from the one or more first objects among the objects is adjusted to an aspect ratio of the display region.

(((2)))

The information processing system according to (((1))), in which:

the processor is configured to configure the second data so that when the page is displayed in the display region, the one or more first objects are placed in the display region on a basis of an origin serving as a basis used to place the one or more first objects in the display region.

(((3)))

The information processing system according to (((2))), in which:

the processor is configured to configure the second data so that when the one or more first objects are placed in the display region, a positional relationship of the origin relative to the display region is maintained and the origin and the one or more first objects maintain a predetermined positional relationship.

(((4)))

The information processing system according to (((2))) or (((3))), in which:

the processor is configured to:

join plural characters represented by the one or more first objects as a character string in a case where the plural characters satisfy a predetermined criterion; and

set the origin for each character or character string represented by the one or more first objects, and

the predetermined criterion is that a spacing between the plural characters satisfies a predetermined criterion, that the plural characters match a character string registered in advance, and/or that a degree of association between the plural characters output by inputting the plural characters to a trained model that outputs a degree of association between characters upon input of the characters satisfies a predetermined criterion.

(((5)))

The information processing system according to any one of (((2))) to (((4))), in which:

the one or more first objects displayed in the display region are vectorized objects, and

the processor is configured to configure the second data so that when the vectorized objects are displayed in the display region, an invisible character holding information on the one or more characters represented by the one or more first objects is placed in the display region on a basis of the origin.

(((6)))

The information processing system according to any one of (((1))) to (((5))), in which:

the second data is configured so that when the page is displayed in the display region, a ratio of a size of the one or more first objects in the display region to a size of the one or more first objects in the page is maintained at a smaller one of a ratio of a height of the display region to a height of the page and a ratio of a width of the display region to a width of the page.

(((7)))

The information processing system according to any one of (((1))) to (((6))), in which:

the processor is configured to configure the second data so that when the page is displayed in the display region, an aspect ratio of a third object that exhibits a function by being read among the objects is restricted within a predetermined range.

(((8)))

The information processing system according to any one of (((1))) to (((7))), in which:

the processor is configured to configure the second data so that when the page is displayed in the display region, auxiliary information added to the objects is displayed by using a hover effect.

(((9)))

An information processing program causing a computer to execute a process for information processing, the process including:

acquiring first data, which is document data segmented per page in which a layout of objects included in a page is fixed; and

generating, from the first data, second data for displaying the page in a display region,

wherein the generating the second data includes configuring the second data so that when the page is displayed in the display region, an aspect ratio of each of one or more first objects representing one or more characters among the objects is restricted within a predetermined range and an aspect ratio of the whole page including a second object different from the one or more first objects among the objects is adjusted to an aspect ratio of the display region.

What is claimed is:

1. An information processing system comprising:
a processor configured to:
acquire first data, which is document data segmented per page in which a layout of objects included in a page is fixed; and
generate, from the first data, second data for displaying the page in a display region,
wherein the generating the second data includes configuring the second data so that when the page is displayed in the display region, an aspect ratio of each of one or more first objects representing one or more characters among the objects is restricted within a predetermined range and an aspect ratio of the whole page including a second object different from the one or more first objects among the objects is adjusted to an aspect ratio of the display region.

2. The information processing system according to claim 1, wherein:
the processor is configured to configure the second data so that when the page is displayed in the display region, the one or more first objects are placed in the display region on a basis of an origin serving as a basis used to place the one or more first objects in the display region.

3. The information processing system according to claim 2, wherein:
the processor is configured to configure the second data so that when the one or more first objects are placed in the display region, a positional relationship of the origin relative to the display region is maintained and the origin and the one or more first objects maintain a predetermined positional relationship.

4. The information processing system according to claim 2, wherein:
the processor is configured to:
join a plurality of characters represented by the one or more first objects as a character string in a case where the plurality of characters satisfy a predetermined criterion; and
set the origin for each character or character string represented by the one or more first objects, and
the predetermined criterion is that a spacing between the plurality of characters satisfies a predetermined criterion, that the plurality of characters match a character string registered in advance, and/or that a degree of association between the plurality of characters output by inputting the plurality of characters to a trained model that outputs a degree of association between characters upon input of the characters satisfies a predetermined criterion.

5. The information processing system according to claim 3, wherein:
the processor is configured to:
join a plurality of characters represented by the one or more first objects as a character string in a case where the plurality of characters satisfy a predetermined criterion; and
set the origin for each character or character string represented by the one or more first objects, and
the predetermined criterion is that a spacing between the plurality of characters satisfies a predetermined criterion, that the plurality of characters match a character string registered in advance, and/or that a degree of association between the plurality of characters output by inputting the plurality of characters to a trained model that outputs a degree of association between characters upon input of the characters satisfies a predetermined criterion.

6. The information processing system according to claim 2, wherein:
the one or more first objects displayed in the display region are vectorized objects, and
the processor is configured to configure the second data so that when the vectorized objects are displayed in the display region, an invisible character holding information on the one or more characters represented by the one or more first objects is placed in the display region on a basis of the origin.

7. The information processing system according to claim 3, wherein:
the one or more first objects displayed in the display region are vectorized objects, and
the processor is configured to configure the second data so that when the vectorized objects are displayed in the display region, an invisible character holding information on the one or more characters represented by the one or more first objects is placed in the display region on a basis of the origin.

8. The information processing system according to claim 1, wherein:
the second data is configured so that when the page is displayed in the display region, a ratio of a size of the one or more first objects in the display region to a size of the one or more first objects in the page is maintained at a smaller one of a ratio of a height of the display region to a height of the page and a ratio of a width of the display region to a width of the page.

9. The information processing system according to claim 2, wherein:
the second data is configured so that when the page is displayed in the display region, a ratio of a size of the one or more first objects in the display region to a size of the one or more first objects in the page is maintained at a smaller one of a ratio of a height of the display region to a height of the page and a ratio of a width of the display region to a width of the page.

10. The information processing system according to claim 3, wherein:
the second data is configured so that when the page is displayed in the display region, a ratio of a size of the one or more first objects in the display region to a size of the one or more first objects in the page is maintained at a smaller one of a ratio of a height of the display region to a height of the page and a ratio of a width of the display region to a width of the page.

11. The information processing system according to claim 1, wherein:
the processor is configured to configure the second data so that when the page is displayed in the display region, an aspect ratio of a third object that exhibits a function by being read among the objects is restricted within a predetermined range.

12. The information processing system according to claim 2, wherein:
the processor is configured to configure the second data so that when the page is displayed in the display region, an aspect ratio of a third object that exhibits a function by being read among the objects is restricted within a predetermined range.

13. The information processing system according to claim 3, wherein:
the processor is configured to configure the second data so that when the page is displayed in the display region, an aspect ratio of a third object that exhibits a function by being read among the objects is restricted within a predetermined range.

14. The information processing system according to claim 1, wherein:
the processor is configured to configure the second data so that when the page is displayed in the display region, auxiliary information added to the objects is displayed by using a hover effect.

15. The information processing system according to claim 2, wherein:
the processor is configured to configure the second data so that when the page is displayed in the display region, auxiliary information added to the objects is displayed by using a hover effect.

16. The information processing system according to claim 3, wherein:
the processor is configured to configure the second data so that when the page is displayed in the display region, auxiliary information added to the objects is displayed by using a hover effect.

17. A non-transitory computer readable medium storing a program causing a computer to execute a process for information processing, the process comprising:
acquiring first data, which is document data segmented per page in which a layout of objects included in a page is fixed; and
generating, from the first data, second data for displaying the page in a display region,
wherein the generating the second data includes configuring the second data so that when the page is displayed in the display region, an aspect ratio of each of one or more first objects representing one or more characters among the objects is restricted within a predetermined range and an aspect ratio of the whole page including a second object different from the one or more first objects among the objects is adjusted to an aspect ratio of the display region.

18. An information processing method comprising:
acquiring first data, which is document data segmented per page in which a layout of objects included in a page is fixed; and
generating, from the first data, second data for displaying the page in a display region,
wherein the generating the second data includes configuring the second data so that when the page is displayed in the display region, an aspect ratio of each of one or more first objects representing one or more characters among the objects is restricted within a predetermined range and an aspect ratio of the whole page including a second object different from the one or more first objects among the objects is adjusted to an aspect ratio of the display region.
